(19) United States
(12) Patent Application Publication
(10) Pub. No.: US 2013/0218692 A1
(43) Pub. Date: Aug. 22, 2013

(54) METHOD AND SYSTEM FOR SELECTION OF FOODSTUFFS

(71) Applicant: William Fischer, Orange, CA (US)

(72) Inventor: William Fischer, Orange, CA (US)

(73) Assignee: FISHER PRINTING, INC, Orange, CA (US)

(21) Appl. No.: 13/809,030

(22) PCT Filed: Jul. 8, 2011
(86) PCT No.: PCT/US2011/043429

§ 371 Date: May 8, 2013

Related U.S. Application Data
(60) Provisional application No. 61/362,420, filed on Jul. 8, 2010.

(51) Int. Cl. G06Q 50/12

(52) U.S. Cl. CPC G06Q 50/12; G06Q 30/0621
USPC 705/15

(57) ABSTRACT

A method and system for online selection of ingredients and/or use with the selection of a prepared foodstuff supplied by a food vendor is provided. The present invention utilizes an online grid system which lists the toppings and/or ingredients which can be included in any particular food item. The grid has a plurality of columns which includes icons with particular food items and allows the consumer to visually indicate the inclusion of specific food ingredients in their food choices. Additionally, the columns allow the individual consumer to determine the amounts of each ingredient to be included in the preparation of a food item and may also include information relating to directing the food vendor where to locate the particular ingredient, such as including only one ingredient on only a part of a foodstuff, for example, a pizza.

### CROSS REFERENCE TO RELATED APPLICATION

This application claims priority to U.S. Provisional Application No, 61/362,420 filed on Jul. 8, 2010.

### FIELD OF THE INVENTION

The field of the invention is a method for selecting food choices. More specifically, the field of invention is for a method and system for selecting toppings and/or ingredients via an online selection system.

### BACKGROUND

The convenience of ordering food online has become very valuable in today's fast paced business oriented world. Traditionally, when ordering food, the individual would need to go to the place that served food, sit down, order their meal and wait till the cook staff prepared the food for them. This required a lot of downtime for the individual that was ordering the food and also caused a considerable waste of time for both the server, order and even the cook staff. Many fast food chains were developed specifically to deal with this problem, as the food was prepared prior to the individual ordering their food. By having the food prepared prior to the individual ordering the food, it greatly reduced wait time for food prep and also wait time for the individual desiring food.

The problem with fast food is that because they are pre-prepared prior to ordering, any customization of the food would require the food preparation staff to freshly prepare the customized order which slows down the response time for receiving food and would increase the wait time for the individual ordering the food. However, many individuals desire that food be customized for their individual tastes and for other reasons including dietary restrictions, diets, religious reasons and the like.

The advent of the phone and internet improved food preparation and ordering ability. By calling ahead, the individual could customize their orders and pick up the food when it was prepared by the institution. However, telephone communication proved to be unreliable because it required a person to answer and it relied on the person answering the phone to properly interpret the desired selections of the individual order. If the order was interpreted incorrectly, the wrong product may have been prepared which not only increase wait time to prepare the correct product, but also wasted food unnecessarily. The use of the internet substantially cut down on improper interpretation of a customer order as it tends to be fully automated, allowing the individual customer to simply click on the desired food selection and this information is forwarded directly to the food preparer on the other end.

However, one problem with online foodstuff ordering, is that selections are usually pre-programmed, whereby the individual must order something from the online website as typically prepared. Therefore, the online customer is stuck with pre-determined selections. There are a few online websites that do allow for customization of foodstuff from a food vendor, but they tend to be very limited. For example, to order a pizza online, some vendors allow the individual customer to choose respective toppings for their pizzas, which is forwarded to the vendor to assemble the pizza. However, the problem with this is that the individual customer can only select toppings and cannot, for example, ask that the pizza be split whereby one half of the pizza be one selected topping and the second half be another topping.

Moreover, another problem with this type of online selection is that it does not give the individual consumer more control over ingredient lists, and options on how much of those ingredients are inserted into the food item. Therefore, the individual would have to contact the food preparer directly and discuss the changes to their order. Again, as enumerated above, it requires that the correct interpretation of the consumer's desires is correctly understood. This is not always the case when the vendor is busy and/or noise causes misunderstanding of the consumer's foodstuff desires.

Therefore, a need exists for a new and improved online ordering system which may allow for further determination and customization of prepared foodstuffs. More specifically, what is needed is an online ordering method that incorporates a plurality of criterion including ingredient lists, options and quantity verifications to allow for more specific ordering abilities for the online consumer.

### SUMMARY OF THE INVENTION

The present invention provides a method and system for online selection of ingredients for use with the selection of a prepared foodstuff supplied by a food vendor. The present invention utilizes an online grid system which lists the toppings and/or ingredients which can be included in any particular food item. The grid has a plurality of columns which includes icons with particular food items and allows the consumer to visually indicate the inclusion of specific food ingredients in their food choices. Additionally, the columns allow the individual consumer to determine the amounts of each ingredient to be included in the preparation of a food item and may also include information relating to directing the food vendor where to locate the particular ingredient, such as including only one ingredient on only a part of a foodstuff, for example, a pizza.

According to the present invention, an online method for selecting ingredients to be forwarded to a foodstuff vendor is provided.

In an exemplary embodiment, an online method and system is provided to allow an individual consumer to select ingredients, and quantities of an ingredient to be provided to a food vendor in the preparation of their individual foodstuffs.

In an exemplary embodiment, an online ordering system, the system comprising: an online web portal for ordering of a foodstuff from a food vendor; said online web portal having a grid with a plurality of columns; said columns including a plurality of option menus for selection by a remote consumer; and said online web portal providing selected information from information input by the remote consumer utilizing the plurality of columns.

In another exemplary embodiment, wherein said columns include at least an icon illustrating ingredients that are selectable by the remote consumer.

In another exemplary embodiment, wherein said columns including selection of a particular ingredient.

In another exemplary embodiment, wherein said columns include the ability to select quantities of a particular selected ingredient to be included on the foodstuffs.

In another exemplary embodiment, wherein the columns include at least the ability to allocate the location of inclusion of a particular selected ingredient on the foodstuff.

In another exemplary embodiment, comprising at least a selection icon for selecting location, quantities and ingredients desired by the remote consumer.

In another exemplary embodiment, comprising nutritional information relating to the selection of a particular ingredient to be included on a food stuff.

In another exemplary embodiment, wherein the information provided by the remote consumer is sent via a network to a food vendor in the preparation of selected food choices by the remote consumer.

In another exemplary embodiment, wherein the plurality of option menus includes at least one column for selected toppings selected by the remote consumer for inclusion on a pizza, and second column for indicating a desired amount of the selected topping, and a third column for indicating a desired location of the selected topping.

In another exemplary embodiment, wherein each column includes an icon indicating a choice made by the remote consumer for each selected topping.

In another exemplary embodiment, wherein at least one column includes an icon indicating a possible choice of the remote consumer for each selected topping.

In an exemplary embodiment, a method for online ordering, the method comprising: providing an online web portal for ordering of a foodstuff from a food vendor having a grid with a plurality of columns including a plurality of option menus for selection by a remote consumer; selecting a combination of ingredients for the foodstuff; altering either an amount or a location of at least one of the selected ingredients for the foodstuff; and providing selected information from information input by the remote consumer utilizing the plurality of columns.

In another exemplary embodiment, comprising updating the web portal after a selection of the combination of ingredients and altering the amount or a location of at least one of the selected ingredients is performed by the remote consumer such that columns include a selection of a particular ingredient.

In another exemplary embodiment, wherein the columns include the ability to allocate the location of inclusion of the particular ingredient on the foodstuff.

In another exemplary embodiment, wherein said columns include the ability to select quantities of the particular ingredient to be included on the foodstuffs.

In another exemplary embodiment, comprising providing at least a selection icon for selecting location, quantities and ingredients desired by the remote consumer.

In another exemplary embodiment, comprising updating the online web portal with nutritional information relating to the selection of a particular ingredient to be included on a food stuff.

In another exemplary embodiment, comprising sending the information provided by the remote consumer via a network to a food vendor in the preparation of selected food choices by the remote consumer.

In another exemplary embodiment, wherein the plurality of option menus includes at least one column for selected toppings selected by the remote consumer for inclusion on a pizza, and second column for indicating a desired amount of the selected topping, and a third column for indicating a desired location of the selected topping.

In another exemplary embodiment, wherein altering either an amount or a location of at least one of the selected ingredients for the foodstuff is performed by a single mouse click.

In an exemplary embodiment, the method and system allows the customer to easily see what toppings or ingredients are included with their food items, in what general locations on or in the food item, and in what amounts. Also it allows the customer to intuitively change the toppings/ingredients, locations, and amounts with quick, simple, individual mouse clicks.

In an exemplary embodiment, the method and system for selecting ingredients and quantities in the preparation of a foodstuff is provided, whereby the online system allows the user to select the ingredients and provide information to the food vendor in the preparation of a foodstuff.

In another exemplary embodiment, an online method and system for selecting toppings, ingredients and other information in the preparation of a food item is provided. The online system comprising a plurality of columns and icons to allow selection by the individual consumer.

In an exemplary embodiment, an online method and system is provided whereby the method allows for the selection of toppings and/or ingredients, their general location, and their amount to be included with a food item being purchased from an online restaurant or store.

In an exemplary embodiment, an online method and system is provided whereby the method allows for allocation of ingredients, quantity and locations of placement of those ingredients in a foodstuff supplied to a vendor for the preparation of a foodstuff.

In yet another exemplary embodiment, an online method and system is provided whereby the method allows for allocation of ingredients, quantity and locations of placement of those ingredients in a foodstuff whereby the system provides a plurality of online selection columns which allows the user to select from the columns.

Still another exemplary embodiment is to provide an online method and system as provided whereby the method allows for allocation of ingredients, quantity and locations of placement of those ingredients in a foodstuff whereby a grid system is used. Whereby the grid system incorporates a plurality of columns including toppings/ingredients, icons illustrating a particular food item and other selectable foodstuff items.

Yet another exemplary embodiment is where an online method and system is provided whereby the method allows for allocation of ingredients, quantity and locations of placement of those ingredients in a foodstuff whereby a grid system is utilized having a plurality of clickable icons and selections that may be made by the individual consumer including ingredient lists, quantities of an ingredient, caloric information relating to those ingredients, and location information relating to the particular ingredients.

It is contemplated an online method and system is provided whereby the method allows for allocation of ingredients, quantity and locations of placement of those ingredients in a foodstuff.

It is contemplated that at least one embodiment of the present invention be utilized in the online ordering of a pizza. The system would present the grid system to the online consumer, whereby the consumer may select the toppings for their pizza and other information including quantity of topping, locations of the toppings and the like. It is contemplated that if a particular icon is blank, then the topping/ingredient is not included with the food item. (Optionally, the icon could be an X, or a crossed out circle, or some other symbol to indicate “not chosen” or “not included.”) If the icon is present, then the topping/ingredient is included and the icon shape indicates the location of the topping/ingredient. For example, with pizzas a whole pizza icon means the topping is included over the entire pizza. A left half pizza icon indicates the topping will only be included on the left half, and a right half pizza icon indicates the topping will only be included on the right half. Optionally a small indicator may also appear with the icon to indicate amount, such as “x2” for double topping, or “x3” for triple topping.

It is further contemplated that for a particular consumer to change the state, all the user has to do is click the appropriate command, button, or check box in the columns to the right. For example, the user might see that the icon next to pepperoni is blank and wish to include pepperoni with their pizza on the right half only. To do so, they merely need to click the label or button titled “Right” and the right half pizza icon will appear next to pepperoni indicating their selection.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

The multiple drawings refer to the embodiments of the invention. While embodiments of the invention described herein is subject to various modifications and alternative forms, specific embodiments thereof have been shown by way of example in the drawings and will herein be described in detail.

FIG. 1 illustrates a representative flow diagram.

FIG. 2A illustrates an exemplary graphical user interface representing a grid system and end product representation.

FIG. 2B illustrates an alternative exemplary graphical user interface grid system.

FIG. 2C illustrates an alternative exemplary graphical user interface grid system.

### DETAILED DESCRIPTION

In the following description of exemplary embodiments, reference is made to the accompanying drawings that form a part hereof, and in which it is shown by way of illustration specific embodiments in which the invention can be practiced. It is to be understood that other embodiments can be used and structural changes can be made without departing from the scope of the embodiments of this invention. As used herein, the terms “couple,” “connect,” and “attach” are interchangeable and include various forms of connecting one part to another either directly or indirectly. Also, it should be appreciated that one or more structural features described in one embodiment could be implemented in a different embodiment, even if not specifically mentioned as being a feature thereof.

In the following description, numerous specific details are set forth, such as examples of selecting and representing a desired order selection for a pizza, in order to provide a thorough understanding of the present invention. It will be apparent, however, to one skilled in the art that the present invention may be practiced without these specific details. For example, embodiments of the present invention may be used with other ordering products, such as other food items or other purchased items in general. For example, any pick-up or pre-ordered food service or provider may take advantage of the disclosed ordering system and methods to provide more accurate and deliberate selection choices to a user. An exemplary alternative use of the described method may be in cake orders, such that the desired selections of fillings, toppings, letterings, etc. may be chosen and customized by a consumer and communicated to a vender. Alternatively, any provider of a finished product may similarly benefit from the disclosed system and method, so that a user can indicate a specific combination of components and items in making their tailored selection. Accordingly, the specific details may be varied and still be within the spirit and scope of the invention.

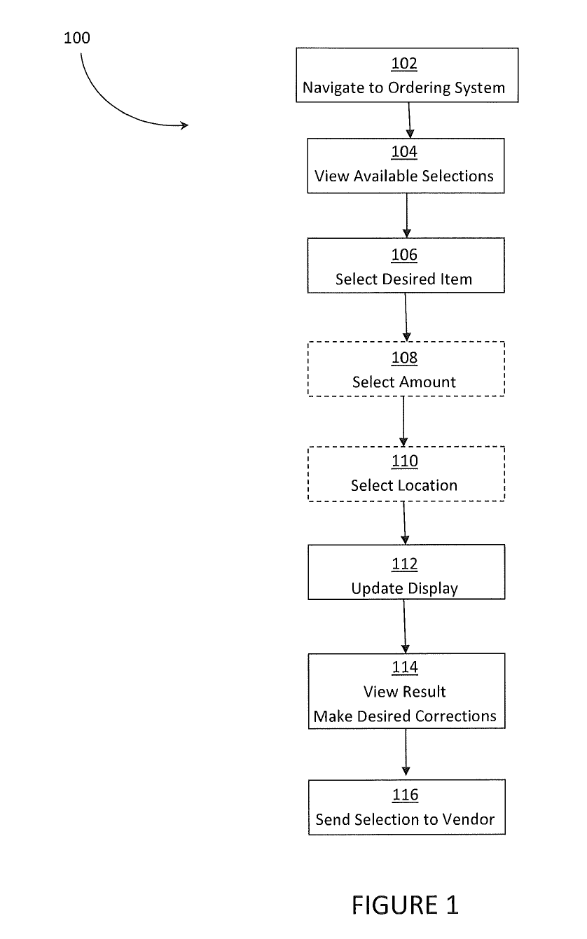

FIG. 1 illustrates a representative flow diagram 100 for an exemplary method for online selection of ingredients for use with the selection of a prepared foodstuff supplied by a food vendor. An individual consumer may use the system accordingly to utilize embodiments of the invention to make a desired selection of a foodstuff including individual accommodations for the individual user.

At block 102, an individual consumer may navigate to the system for ordering the prepared foodstuff. For example, this may be a website hosted by the food vendor. The website may include an interface for providing the selection of an item, the desired amount, and the indication of a desired location on or within the foodstuff. Before reaching the selection interface, the system may receive information from the individual consumer such as, for example, an address, phone number, delivery preferences, desired time for order completion, etc.

Embodiments described herein are generally described in terms of an online website interface for presenting the system for making a desired selection. However, embodiments are not so limited but may also include other ordering forms or programs made available to an individual consumer from the vendor. For example, mobile applets are also contemplated or other downloadable programs. In such an embodiment, a user may download or otherwise launch a program to make the desired selections. The system may then codify these selections in a sendable form, such as an email or other data packet, that is received by the vendor. In one embodiment, the consumer selections are sent in a form that is directly received by the vendor's ordering system, such that the individual consumer's order is queued with the waiting orders, as if made directly by the vendor, without vendor intervention.

At block 104, the individual consumer may view available selections of the desired foodstuff through a graphical interface. The graphical interface provides an easy visualization of the desired selections. For example, an online grid system is used to list the ingredients which can be included in any particular food item. The grid has a plurality of columns which include icons with particular food items and allows the consumer to visually indicate the inclusion of specific ingredients. Additionally, the columns allow the individual consumer to determine the amount of each ingredient to be included in the preparation of a food item, and may also include information relating to directing the food vendor where to locate the particular ingredient, such as including only one ingredient on only a part of the foodstuff.

At block 106, the individual consumer may make the desired selection through the graphical interface. For example, the user may select the desired icons from the online grid system to select the desired items. Additional selections for the desired amount or location may also be made by selecting the appropriate icons, at blocks 108 and 110. A selection of the primary item may automatically default the selection of the amount and location to a pre-determined amount. The pre-determined amount may be based on the foodstuff or on user preferences. Thus, an additional selection of the amount and/or location may not be necessary for every selected item.

At block 112, the graphical interface may be updated based on the individual consumer's selection. For example, various selection boxes may be updated to indicate the desired selections. An end representation of the combination of selections may also be updated and presented to the consumer for inspection. Additional information may be updated and displayed to a user, such as a cost total or caloric total, based on the combination of choices. The graphical interface may be updated upon a request of the user, upon an indication that the desired selections are complete, or may be automatically updated after each selection. Different update times, processing power, and data band transfer rates are required for each alternative, and may be selected based on the interface of the consumer.

At block 114, the individual consumer is permitted to view the results of the selection process. The graphical user interface permits easy viewing of the desired selections, and alterations made to the ordered foodstuff. For example, the grid system including a plurality of columns may be used to indicate the various selections and alternations made by the individual consumer. A graphical representation of the end product may also be depicted for final review by the consumer. The consumer may review the selection and may make any desired corrections through easy manipulation of the graphical interface. For example, opposing icons may be selected to deselect or alternatively select different options for the food choice. Thus, the graphical user interface provides for easy viewing and correction through single or few mouse clicks.

Once the desired selection is confirmed, at block 118, the selection is sent to the vendor to fill the order. The vendor may receive the individual consumer's selection in a variety of interfaces. For example, the selection may be stored on a secure on-line form that is accessed by the vendor at their convenience. An alert may be provided to the vendor indicating the immediate receipt of the selection. Alternatively, the individual consumer's selection may be integrated with the vendor's generally ordering interface, such that the individual consumer's order is queued with the other pending orders of the vendor, with or without first requiring a vendor's review.

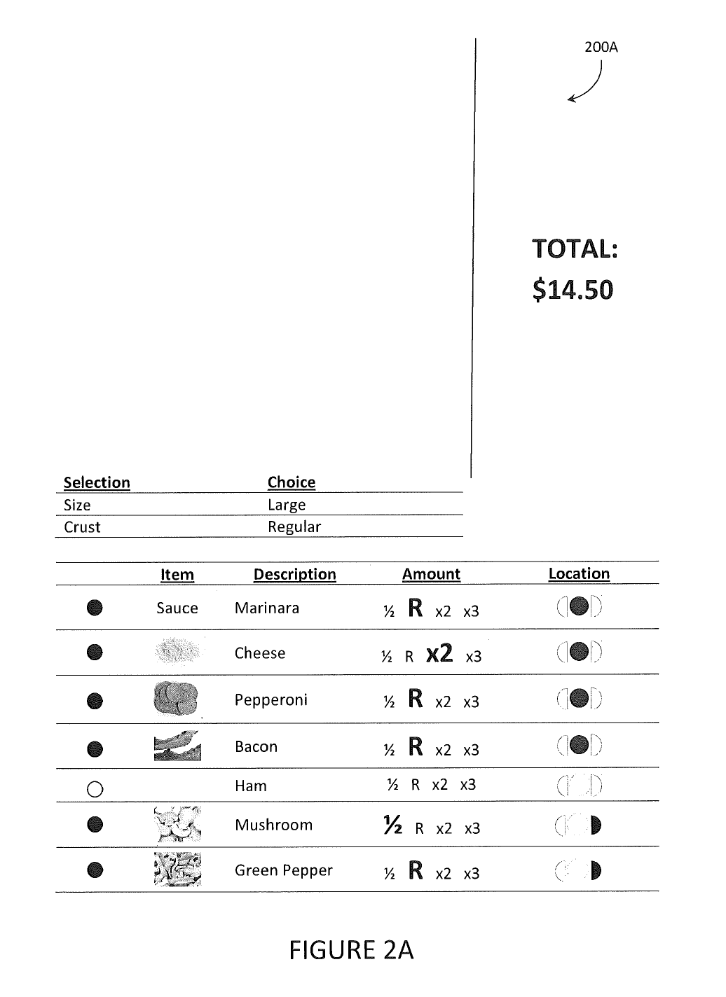

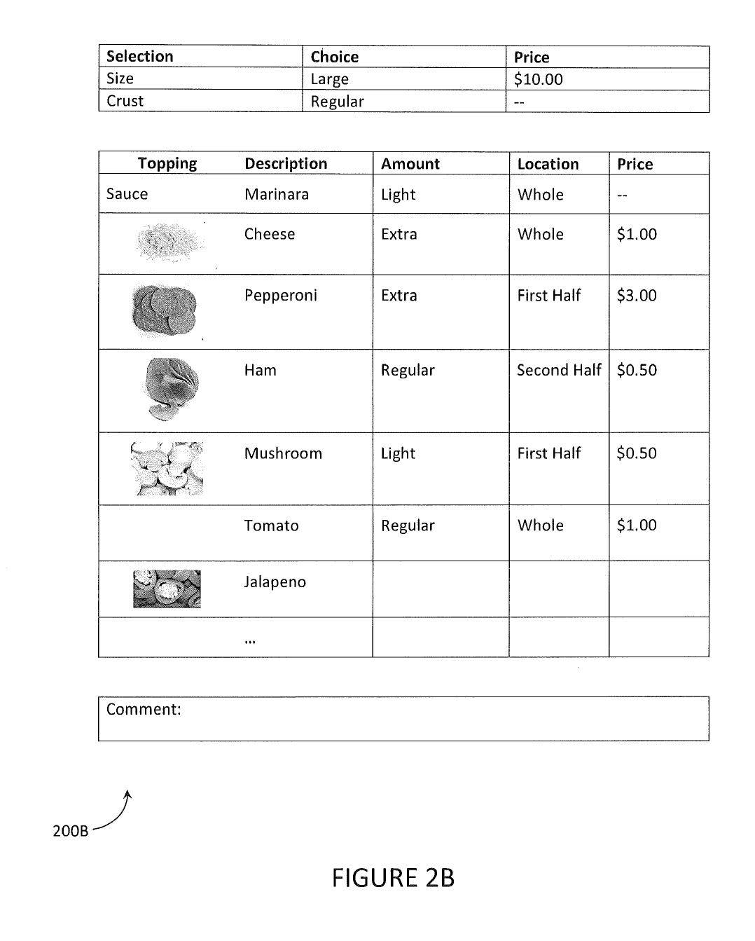

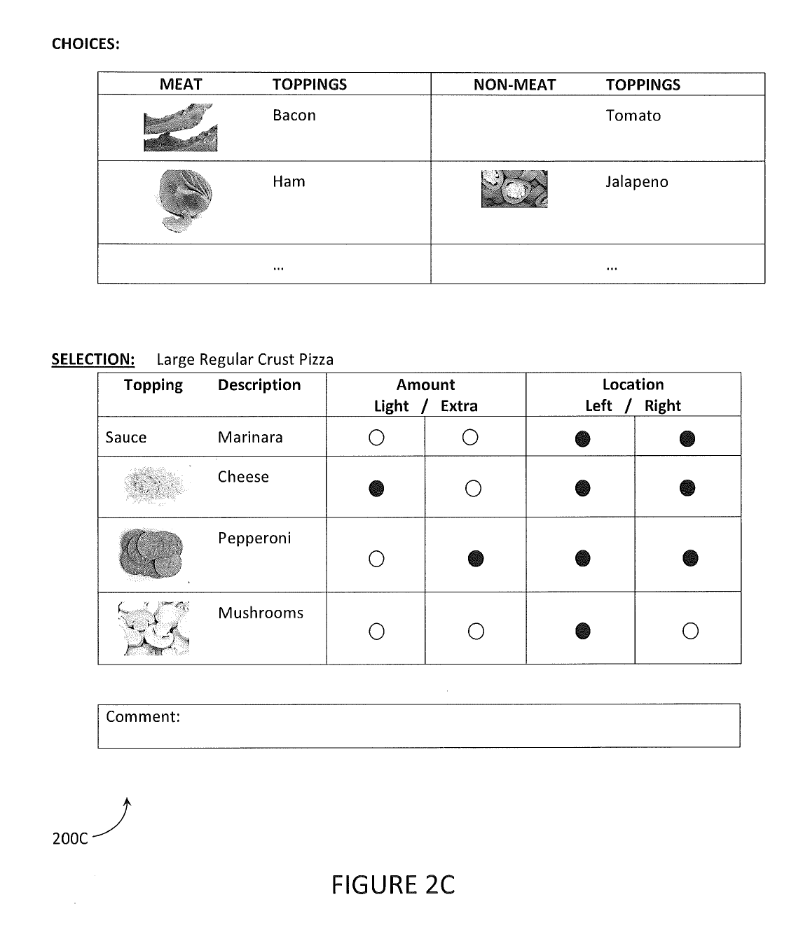

FIG. 2 illustrates an exemplary graphical user interface used in conjunction with the above described method of providing an online selection of a prepared foodstuff supplied by a food vendor. The graphical user interface permits an individual consumer to easily see the available options, the selected items, as well as alterations made to those items, such as in a quantity and/or location. The graphical user interface also permits easy update and changes to the selections made. In an exemplary embodiment, the graphical user interface includes a grid system to display the selections made, and a end product representation resulting from the combination of the a consumer's selection.

For example, as seen in FIG. 2A, an exemplary graphical user interface 200A is represented including a grid system and end product representation used in the selection of a pizza by an individual consumer. The end product representation illustrates an exemplary pizza made according to the selections of the individual consumer. The end product representation provides a visual confirmation of the choices made by the individual consumer.

The exemplary graphical user interface 200A also includes a grid system for providing the available selections, the selected items, and any alterations made to those items, such as a quantity and a location. For example, a first exemplary grid system may include a plurality of columns and icons to allow the selection of individual toppings, the quantity of the selected topping, and the location of the topping selected. The grid system may provide either a visual representation or written description or both a graphical and written description of the available toppings. A user may select one of these toppings by either clicking on a radio button or other selection box, clicking the icon directly, or selecting one or more of the options associated with the selection, thus indicating the inclusion of that item. The graphical user interface may indicate the selected items by altering the icon associated with the selected item. For example, if pepperoni were selected as a desired topping, a radio button may fill in, a graphical representation of the pepperoni may appear, and/or other associated selections of the item may appear, as described below. As shown in FIG. 2A, a selection circle indicates a selected item by a black circle and a non-selected item with a white circle. The graphical user interface also illustrates a visual representation of the selected item next to a written description of that item. One or more of these options may be used individually or in conjunction to indicate the inclusion of an item. Similarly, the written description may be used instead of the graphical representation. Alternatively, the location icon and/or the amount icon, as described more fully below, may be used as one or more of the indications of the presence or absence of a desired selection.

The grid system may also include columns associated with various alterations that may be made to the selected food item. For example, in the selection of a pizza topping, the amount of the topping (such as an extra or lesser portion) may be indicated, or the selection of the location of the topping, such as on only half of the pizza may also or alternatively be indicated. The location icon may be represented by an alternative selection of either the left side, the entire, or the right side of the pizza. The selection may be represented by a half circle for each side, and a whole circle for the entire pizza. The selection may be indicated through a different color or size. Thus, an individual consumer needs only select the desired option to choose or make changes to the item. Similarly, the quantity may be represented as either a lesser amount, regular amount, extra amount, or more. As shown in FIG. 2A, the lesser amount is indicated by a “½”, regular by “R”, extra by either “x2” or “x3” depending on the desired addition. The selection may be indicated by a character change, such as in size, weight, or font.

As seen in FIG. 2A, the grid system provides a list of all toppings available to an individual consumer. To make a selection, the individual consumer merely clicks on the selected circle, item description, amount, or location icons to indicate the inclusion of the item. The system may automatically update the remaining selections to a default selection according to predefined rules. For example, if a user merely selects the item, the system may default to the regular quantity and the entire pizza as the location. The system may also track user preferences and may make the appropriate selections based on ordering history. To unselect an item, the user may similarly click on the selection circle, item description, selected amount, or location to deselect that item. Alterations may be made in either the amount or location my merely clicking on the desired selection from the indicated icons. The end product representation may update based on the selections made by the individual consumer to provide a verification of the selections made.

The graphical user interface may include additional information, such as the total cost or total calories resulting from the selections made. Additional grid systems may be included to indicate other selections as well. For example, as seen in FIG. 2A, the selection of the size and crust type of the pizza may be illustrated in a separate grid system. Inclusion of side items, such as breadsticks, drinks, buffalo wings, etc., may also be included in one or more additional grid systems, as appropriate.

Accordingly, the system provides for the selection of an item, amount, and location of that item. The system additionally provides the easy visualization of those selections. The system permits intuitive changes through quick, simple, individual mouse clicks.

FIG. 2B illustrates an alternative exemplary graphical user interface 200B including a grid system used in the selection of a pizza by an individual consumer. As seen, the grid system may utilize written descriptions as the representative icons for the desired selections. Also, the grid system may only present the chosen selection of the individual consumer. Alternatively selections of a user may be seen by either hovering over the selection, through a drop down menu, or other alternative selection method. Accordingly, a user may change a selection by either hovering or clicking on the selection and making the appropriate change from a provided list. The grid system may include additional columns for added information for the user, such as the price per item or calories of the item (not shown) based on the selection made. A comment field or additional grid system may be included to further provide instructions to the foodstuff vendor.

As seen in FIG. 2B, a user selects a pizza topping by choosing the desired amount or location of the topping. The system may then update the remaining information of the selection including the price, corresponding location or amount to a default setting. Alternatively, once a selection is made, the system may prompt the user to make the additional selections automatically. Such as, for example, when a topping item is made by selecting a regular amount of ham, a pop-up box or other input device may appear requesting if the entire pizza is desired. If not, the user may make the desired selection of either the first or second half of the pizza. An end product representation may not be included to reduce processing power or speed to support the ordering application. For example, for a user over a slower internet connection, or using an applet interface over a mobile device, the end product representation may be too computationally complex to support efficiently and timely.

FIG. 2C illustrates an alternative exemplary graphical user interface 200C including a grid system used in the selection of a pizza by an individual consumer. Various embodiments as described herein of the system may be utilized in conjunction to create the desired interface for a particular application. The graphical user interface may further be altered to include additional selection options for an individual consumer. Alternative icons may be used for the graphical representations of the selected amounts. For example, the quantity or amount of a selected item may be indicated by a numeric range (for example, 1-5 with 3 being “regular”), graphical symbols, such as one or more + or − indicators for extra or lesser amounts. Various selection options as described above may be included in one or more grid systems. For example, the topping selection may be displaced from the remaining sub-selection choices, such that the entire topping options list is displaced from the selected options list. In such a representation, a graphical and/or written list of options may be provided to a user. Upon selection of an individual item, that item may be removed from the possible selection list and incorporated into the grid system to provide the additional sub-selections of the amount and location. Thus, the selection grid system only indicates the selected toppings of an individual consumer along with its amount and location. The options grid system merely provides a list of possible toppings available to a consumer, but does not otherwise indicate further quantity or location options, until selected.

The ordering may also be compartmentalized, such that preliminary information is obtained by the vendor before selected portions of the ordering process commences. For example, a vendor may receive contact information from the individual consumer before proceeding to the selection options. Additionally, the ordering options may be presented departmentally. For example, a user may first select the size and crust associated with a pizza, or even if a “specialty” or prearranged ingredient pizza is desired. Once these selections are made, the individual consumer may be presented with the toppings according to the previous selections and available for alterations. Therefore, if a specialty pizza was pre-selected, the ingredients for that specialty may already appear as selected in an associated quantity for that selection. The individual user may then simply alter those pre-defined selections as desired.

The exemplary embodiment describes using icons to visually represent a selection or desired item. As used herein “icon” is intended to include all graphical representations of an item including a written or pictorial representation to indicate the desired selection. For example, words may be used to describe a selection or a graphical image of the selection may be represented. Alternatively, the icon may include a symbol or other representation to indicate the desired selection, but that is unrelated to the selected item, such as, for example, checks, x's, filled box, radio button, or other representation used to indicate the inclusion of an item.

As described herein, various methods and systems are described for online selection of ingredients for use with the selection of prepared foodstuff supplied by a food vendor. These methods may be performed by logic to accomplish the required functions. The required logic may be performed by processing logic that may comprise hardware (circuitry, dedicated logic, state machines, etc.), software (such as is run on a general purpose computer system or a dedicated machine), or combinations of both. A special purpose computer may be programmed to perform the disclosed algorithms. Also, “online” selection includes any selection made between one computer to another through a direct or indirect connection or network. Such an online selection may be made, for example, over the internet or world wide web through a website interface. Alternatively the online selection may be made through a utility program for performing only the functions as described herein for implementing the system and method for online selection. Such a program may be launched by a mobile device, such as an applet from a smart phone. The online selection is then wirelessly sent to the vendor computer.

Some portions of the detailed descriptions above are presented in terms of methods performed “online.” These methods are implemented as algorithms. These algorithms may be symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages. Also, an algorithm may be implemented with lines of code in software, configured logic gates in software, or a combination of both.

In one embodiment, the software used to facilitate the algorithm can be embodied onto a machine-readable medium. A machine-readable medium includes any mechanism that provides (e.g., stores and/or transmits) information in a form readable by a machine (e.g., a computer). For example, a machine-readable medium includes read only memory (ROM); random access memory (RAM); magnetic disk storage media; optical storage media; flash memory devices; Digital Video Disc (DVD's), EPROMs, EEPROMs, FLASH memory, magnetic or optical cards, or any type of media suitable for storing electronic instructions.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers, or other such information storage, transmission or display devices.

In an embodiment, the logic consists of electronic circuits that follow the rules of Boolean Logic, software that contain patterns of instructions, or any combination of both.

While some specific embodiments of the invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The invention is to be understood as not limited by the specific embodiments described herein, but only by scope of the appended claims.

1. An online ordering system, the system comprising:
an online web portal for ordering of a foodstuff from a food vendor;
said online web portal having a grid with a plurality of columns;
said columns including a plurality of option menus for selection by a remote consumer; and
said online web portal providing selected information from information input by the remote consumer utilizing the plurality of columns.

2. The system described in claim 1 wherein said columns include at least an icon illustrating ingredients that are selectable by the remote consumer.

3. The system described in claim 1 wherein said columns including selection of a particular ingredient.

4. The system described in claim 1 wherein said columns include the ability to select quantities of a particular selected ingredient to be included on the foodstuffs.

5. The system described in claim 1 wherein the columns include at least the ability to allocate the location of inclusion of a particular selected ingredient on the foodstuff.

6. The system described in claim 1 further comprising at least a selection icon for selecting location, quantities and ingredients desired by the remote consumer.

7. The system described in claim 1 further comprising nutritional information relating to the selection of a particular ingredient to be included on a food stuff.

8. The system described in claim 1 wherein the information provided by the remote consumer is sent via a network to a food vendor in the preparation of selected food choices by the remote consumer.

9. The system described in claim 1 wherein the plurality of option menus includes at least one column for selected toppings selected by the remote consumer for inclusion on a pizza, and second column for indicating a desired amount of the selected topping, and a third column for indicating a desired location of the selected topping.

10. The system described in claim 9 wherein each column includes an icon indicating a choice made by the remote consumer for each selected topping.

11. The system described in claim 10 wherein at least one column includes an icon indicating a possible choice of the remote consumer for each selected topping.

12. A method for online ordering, the method comprising:
providing an online web portal for ordering of a foodstuff from a food vendor having a grid with a plurality of columns including a plurality of option menus for selection by a remote consumer;
selecting a combination of ingredients for the foodstuff;
altering either an amount or a location of at least one of the selected ingredients for the foodstuff; and
providing selected information from information input by the remote consumer utilizing the plurality of columns.

13. The method described in claim 12 further comprising updating the web portal after a selection of the combination of ingredients and altering the amount or a location of at least one of the selected ingredients is performed by the remote consumer such that columns include a selection of a particular ingredient.

14. The method described in claim 13 wherein the columns include the ability to allocate the location of inclusion of the particular ingredient on the foodstuff.

15. The method described in claim 14 wherein said columns include the ability to select quantities of the particular ingredient to be included on the foodstuffs.

16. The method described in claim 12 further comprising providing at least a selection icon for selecting location, quantities and ingredients desired by the remote consumer.

17. The method described in claim 12 further comprising updating the online web portal with nutritional information relating to the selection of a particular ingredient to be included on a food stuff.

18. The method described in claim 1 further comprising sending the information provided by the remote consumer via a network to a food vendor in the preparation of selected food choices by the remote consumer.

19. The method described in claim 1 wherein the plurality of option menus includes at least one column for selected toppings selected by the remote consumer for inclusion on a pizza, and second column for indicating a desired amount of the selected topping, and a third column for indicating a desired location of the selected topping.

20. The method described in claim 1 wherein altering either an amount or a location of at least one of the selected ingredients for the foodstuff is performed by a single mouse click.
